(19) United States
(12) Patent Application Publication
(10) Pub. No.: US 2016/0282655 A1
(43) Pub. Date: Sep. 29, 2016

(54) LIQUID CRYSTAL DISPLAY PANEL AND DISPLAY APPARATUS

(71) Applicants: BOE TECHNOLOGY GROUP CO., LTD., Beijing (CN); HEFEI BOE OPTOELECTRONICS TECHNOLOGY CO., LTD., Hefei (CN)

(72) Inventor: Feng Yu, Beijing (CN)

(21) Appl. No.: 14/803,592

(22) Filed: Jul. 20, 2015

(30) Foreign Application Priority Data
Mar. 23, 2015 (CN) 201510130233.8

(51) Int. Cl. G02F 1/1339; G02F 1/1335

(52) U.S. Cl. CPC G02F 1/13394; G02F 1/133514; G02F 1/133512; G02F 2001/13396; G02F 2001/13398

(57) ABSTRACT

A liquid crystal display panel comprises: a first substrate and a second substrate disposed opposite to each other; a liquid crystal layer between the first substrate and the second substrate; and a first spacer between the first substrate and the second substrate. A hole is formed in an outer wall of the first spacer, and liquid crystals in the liquid crystal layer can enter an inside of the first spacer through the hole.

### CROSS-REFERENCE TO RELATED APPLICATION

This application claims the benefit of Chinese Patent Application No. 201510130233.8 filed on Mar. 23, 2015 in the State Intellectual Property Office of China, the whole disclosure of which is incorporated herein by reference.

### BACKGROUND OF THE INVENTION

1. Field of the Invention

Embodiments of the present invention relate to the field of display, and particularly to a liquid crystal display panel and a display apparatus.

2. Description of the Related Art

A conventional liquid crystal display panel comprises a color filter substrate, an array substrate, and a liquid crystal layer between the color filter substrate and the array substrate. A thickness of the liquid crystal layer is mainly controlled by a height of spacers between the array substrate and the color filter substrate. The thickness of the liquid crystal layer has an important influence on structural parameters and display quality of the liquid crystal display apparatus.

At present, generally the spacer in the liquid crystal display panel is a column-shaped spacer. Generally, the column-shaped spacers are formed on the color filter substrate by processes such as mask and photolithographic processes. The liquid crystal display panel is formed by assembling the color filter substrate and the array substrate together. The column-shaped spacers between the color filter substrate and the array substrate support the two substrates such that both display effect and display quality of the liquid crystal display panel can reach good levels. However, when the liquid crystal display apparatus is used in a particular environment, and for example, when the liquid crystal display panel is used at a high temperature, liquid crystals in the liquid crystal display panel will sink under the compositive action of the high temperature and gravity so that a phenomenon of uneven color (color spot), i.e., gravity mura, occurs at a lower edge of the liquid crystal display panel.

### SUMMARY OF THE INVENTION

Embodiments of the present invention provide a liquid crystal display panel comprising: a first substrate and a second substrate disposed opposite to each other; a liquid crystal layer between the first substrate and the second substrate; and a first spacer between the first substrate and the second substrate, wherein a hole is formed in an outer wall of the first spacer, and liquid crystals in the liquid crystal layer can enter an inside of the first spacer through the hole.

Embodiments of the present invention also provide a display device comprising the above-mentioned liquid crystal display panel.

### BRIEF DESCRIPTION OF THE DRAWINGS

FIG. 1 is a partial schematic diagram of a liquid crystal display panel according to an embodiment of the present invention;

FIG. 2 is a partial schematic diagram of a liquid crystal display panel according to another embodiment of the present invention; and

FIG. 3 is a schematic diagram of a second column-shaped spacer according to an embodiment of the present invention.

### DETAILED DESCRIPTION OF THE EMBODIMENTS

A further description of the invention will be made in detail as below with reference to embodiments of the present invention taken in conjunction with the accompanying drawings. The following embodiments are intended to explain the present invention and the present invention should not be construed as being limited to the embodiment set forth herein.

According to a general concept of embodiments of the present invention, there is provided a liquid crystal display panel comprising: a first substrate and a second substrate disposed opposite to each other; a liquid crystal layer between the first substrate and the second substrate; and a first spacer between the first substrate and the second substrate, wherein a hole is formed in an outer wall of the first spacer, and liquid crystals in the liquid crystal layer can enter an inside of the first spacer through the hole.

According to a general concept of embodiments of the present invention, there is also provided a display device comprising the above-mentioned liquid crystal display panel.

In the liquid crystal display panel according to the embodiments of the present invention, the hole is formed in the outer wall of the first column-shaped spacer between the color filter substrate and the array substrate. Thereby, when the liquid crystal display panel is in a high-temperature environment, liquid crystals in the liquid crystal layer can enter the inside of the first column-shaped spacer through the hole so that an amount of liquid crystals in the liquid crystal layer is less than that in a normal-temperature environment. As a result, the influence of the gravity mural effect occurring in the liquid crystal display panel in the high-temperature environment can be effectively alleviated.

A further description of the invention will be made in detail as below with reference to embodiments of the present invention taken in conjunction with the accompanying drawings. In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

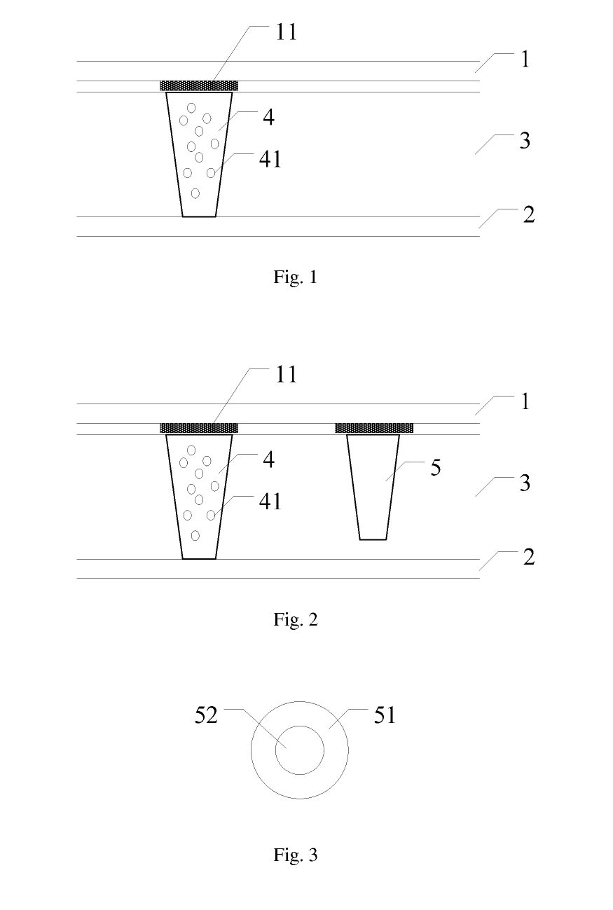

FIG. 1 is a partial schematic diagram of a liquid crystal display panel according to an embodiment of the present invention. As shown in FIG. 1, The liquid crystal display panel comprises: a color filter substrate 1 and an array substrate 2 (as a first substrate and a second substrate) disposed opposite to each other; a liquid crystal layer 3 between the color filter substrate 1 and the array substrate 2; and a first column-shaped spacer 4 between the color filter substrate 1 and the array substrate 2. A hole 41 is formed in an outer wall of the first column-shaped spacer 4, and liquid crystals in the liquid crystal layer 3 can enter an inside of the first column-shaped spacer 4 through the hole 41.

In the liquid crystal display panel according to the embodiments of the present invention, the hole is formed in the outer wall of the first column-shaped spacer between the color filter substrate and the array substrate. Thereby, when the liquid crystal display panel is in a high-temperature environment, liquid crystals in the liquid crystal layer can enter the inside of the first column-shaped spacer through the hole so that an amount of liquid crystals in the liquid crystal layer is less than that in a normal-temperature environment. As a result, the influence of the gravity mural effect occurring in the liquid crystal display panel in the high-temperature environment can be effectively alleviated.

In some embodiments, the first column-shaped spacer 4 in the liquid crystal display panel may be made of a photoresist and may have an outer shape of a truncated cone or a frustum of a cone. For example, an accommodation chamber which is in communication with the hole 41 in the outer wall may also be formed inside the first column-shaped spacer. By disposing all or some of spacers between the color filter substrate and the array substrate into the above-mentioned the first column-shaped spacers, when the liquid crystal display panel is in a high-temperature environment, the liquid crystals in the liquid crystal layer will expand in volume due to a rise in temperature so that some of the liquid crystals can enter the inside of the first column-shaped spacer through the hole in the outer wall of the first column-shaped spacer, thereby decreasing an amount of the liquid crystals in the liquid crystal layer on an outside of the first column-shaped spacer. As a result, the influence of the gravity mura effect occurring in the liquid crystal display panel in the high-temperature environment can be effectively alleviated, while breakage of sealing adhesive between the color filter substrate and the array substrate due to expansion of the liquid crystals and pollutions can also be avoided.

FIG. 2 is a partial schematic diagram of a liquid crystal display panel according to another embodiment of the present invention. As shown in FIG. 2, The liquid crystal display panel comprises: a color filter substrate 1 and an array substrate 2 (as a first substrate and a second substrate) disposed opposite to each other; a liquid crystal layer 3 between the color filter substrate 1 and the array substrate 2; and a first column-shaped spacer 4 and a second column-shaped spacer 5 which are disposed between the color filter substrate 1 and the array substrate 2. A hole 41 is formed in an outer wall of the first column-shaped spacer 4, and liquid crystals in the liquid crystal layer 3 can enter an inside of the first column-shaped spacer 4 through the hole 41. The second column-shaped spacer 5 has a height not greater than the first column-shaped spacer 4, and the second column-shaped spacer 5 may have a greater stiffness than the first column-shaped spacer 4.

In the liquid crystal display panel according to the embodiments of the present invention, the hole is formed in the outer wall of the first column-shaped spacer between the color filter substrate and the array substrate. Thereby, when the liquid crystal display panel is in a high-temperature environment, liquid crystals in the liquid crystal layer can enter the inside of the first column-shaped spacer through the hole so that an amount of liquid crystals in the liquid crystal layer is less than that in a normal-temperature environment. As a result, the influence of the gravity mural effect occurring in the liquid crystal display panel in the high-temperature environment can be effectively alleviated. In addition, by additionally disposing the second column-shaped spacer, having a greater stiffness than the first column-shaped spacer, between the color filter substrate and the array substrate, a pressure resistance of the liquid crystal display panel in a direction perpendicular to the liquid crystal display panel can be improved.

For example, in order that the second column-shaped spacer has a greater stiffness than the first column-shaped spacer, the first column-shaped spacer may be made of a photoresist, and the entire second column-shaped spacer or a part of the second column-shaped spacer may be made of a rigid material. The rigid material may comprise a metal material, a hard plastic, or other harder materials. For example, as shown in FIG. 3, a column-shaped body 51 of the second column-shaped spacer may be made of a photoresist, and a support 52 made of a rigid material is disposed in the column-shaped body 51 and extends in a height direction of the column-shaped body (i.e., a height direction of the spacer), thereby increasing a supporting force of the second column-shaped spacer in the height direction. In addition, a hole or a sealed space may also be formed in the second column-shaped spacer. The hole or the sealed space may extend in the height direction of the second column-shaped spacer, and the support made of a rigid material is disposed in the hole or the sealed space.

The first column-shaped spacer may have a height of 1 μm-10 μm. For example, the first column-shaped spacer may have a height of 3 μm, 6 μm, 9 μm or the like. The second column-shaped spacer may have a height of 0.5 μm-10 μm. For example, the second column-shaped spacer may have a height of 2 μm, 5 μm, 8 μm or the like. The first and second column-shaped spacers may have the same or different heights. For example, the height of the second column-shaped spacer may be less than the height of the first column-shaped spacer, and the first column-shaped spacer has two ends which are in contact with the color filter substrate and the array substrate, respectively, so as to play a primary supporting role; and the second column-shaped spacer has one end which is disposed on one of the substrates, and the other end which is not in contact with the other of the substrates under normal conditions and which can come into contact with the other of the substrates only under the action of an external force, so as to play an auxiliary supporting role, thereby preventing damage to the first column-shaped spacer due to an excessive amount of compressions to the first column-shaped spacer.

In addition, the first and second column-shaped spacers may have the same or different specific shapes. For example, the first and second column-shaped spacers may all have a cross-sectional shape of a trapezoid in a direction perpendicular to the display panel, and may have a cross-sectional shape of a circle, a ellipse, a polygon, or the like, in a direction parallel to the display panel.

In some embodiments, in order to avoid an adverse effect on light transmittance of the liquid crystal display panel, the first and second column-shaped spacers may be disposed in correspondence with a black matrix on the color filter substrate. For example, the first and second column-shaped spacers may be disposed to face the black matrix on the color filter substrate. The first and second column-shaped spacers may all be formed on the color filter substrate or may be formed on the array substrate. For example, the first column-shaped spacer may have one end fixed to the color filter substrate and the other end being in contact with the array substrate, so as to play a primary supporting role; and the second column-shaped spacer has one end fixed to the color filter substrate and the other end being not in contact with the array substrate under normal conditions while coming into contact with the array substrate only under the action of an external force, so as to play an auxiliary supporting role, thereby preventing damage to the first column-shaped spacer due to an excessive amount of compressions to the first column-shaped spacer.

In the liquid crystal display panel according to the embodiments of the present invention, on one hand, the hole is formed in the outer wall of the first column-shaped spacer between the color filter substrate and the array substrate. Thereby, some of the liquid crystals can be locked in the inside of the first column-shaped spacer in a high-temperature environment so that an amount of liquid crystals in the liquid crystal layer is less than that in a normal-temperature environment. As a result, the influence of the gravity mural effect due to diffusion of the liquid crystals in the liquid crystal display panel in the high-temperature environment can be effectively buffered. On the other hand, by additionally disposing a plurality of sets of second column-shaped spacers, each having a greater stiffness than the first column-shaped spacer, between the color filter substrate and the array substrate, when the liquid crystal display panel suffers a pressure perpendicular to the surface of the liquid crystal display panel, a pressure resistance of the liquid crystal display panel can be remarkably improved.

In addition, embodiments of the present invention also provide a display device comprising the above-mentioned liquid crystal display panel. Specifically, the display apparatus according to the embodiments of the present invention may comprise any products or parts having displaying function, such as a display screen of a notebook computer, a liquid crystal display, a liquid crystal TV, a digital frame, a mobile phone or a tablet computer.

Although the spacers are the column-shaped spacers and the body of the spacer is the column-shaped body in the above embodiments, the first and second spacers and the body of the second spacer may also have any other appropriate shapes.

The above embodiments are only used to explain the present invention, and should not be construed to limit the present invention. It will be understood by those skilled in the art that various changes and modifications may be made therein without departing from the spirit of the present invention, the scope of which is defined in the appended claims and their equivalents.

1. A liquid crystal display panel comprising:
a first substrate and a second substrate disposed opposite to each other;
a liquid crystal layer between the first substrate and the second substrate; and
a first spacer between the first substrate and the second substrate, wherein a hole is formed in an outer wall of the first spacer, configured for liquid crystals in the liquid crystal layer to enter an inside of the first spacer through the hole.

2. The liquid crystal display panel of claim 1, further comprising:
an accommodation chamber which is formed inside the first spacer and is in communication with the hole.

3. The liquid crystal display panel of claim 1, further comprising:
a second spacer disposed between the first substrate and the second substrate and having a height not greater than the first spacer.

4. The liquid crystal display panel of claim 3, wherein:
the second spacer has a greater stiffness than the first spacer.

5. The liquid crystal display panel of claim 3, wherein:
the first spacer is made of a photoresist, and the entire second spacer or a part of the second spacer is made of a rigid material.

6. The liquid crystal display panel of claim 5, wherein:
the second spacer comprises a body made of a photoresist and a support disposed in the body, made of the rigid material and extending in a height direction of the body.

7. The liquid crystal display panel of claim 5, wherein:
the rigid material comprises a metal material or a hard plastic.

8. The liquid crystal display panel of claim 3, wherein:
the first spacer has a height of 1 μm-10 μm, and the second spacer has a height of 0.5 μm-10 μm.

9. The liquid crystal display panel of claim 3, wherein:
a black matrix is disposed on the first substrate, and the first and second spacers are disposed in correspondence with the black matrix on the first substrate.

10. The liquid crystal display panel of claim 9, wherein:
the first spacer has a first end fixed to the first substrate and a second end being in contact with the second substrate; and
the second spacer has a first end fixed to the first substrate and a second end being out of contact with the second substrate.

11. The liquid crystal display panel of claim 2, further comprising:
a second spacer disposed between the first substrate and the second substrate and having a height not greater than the first spacer.

12. The liquid crystal display panel of claim 11, wherein:
the second spacer has a greater stiffness than the first spacer.

13. The liquid crystal display panel of claim 11, wherein:
the first spacer is made of a photoresist, and the entire second spacer or a part of the second spacer is made of a rigid material.

14. The liquid crystal display panel of claim 13, wherein:
the second spacer comprises a body made of a photoresist[N] and a support disposed in the body, made of the rigid material, and extending in a height direction of the body.

15. The liquid crystal display panel of claim 3, wherein:
the first spacer has a first end fixed to the first substrate and a second end being in contact with the second substrate; and
the second spacer has a first end fixed to the first substrate and a second end being out of contact with the second substrate.

16. The liquid crystal display panel of claim 1, wherein:
the first spacer has a column shape.

17. The liquid crystal display panel of claim 2, wherein:
the second spacer has a column shape.

18. The liquid crystal display panel of claim 6, wherein:
the body of the second spacer has a column shape.

19. The liquid crystal display panel of claim 1, wherein:
the first substrate is a color filter substrate and the second substrate is an array substrate.

20. A display apparatus comprising the liquid crystal display panel according to claim 1.
